(19) United States
(12) Patent Application Publication
(10) Pub. No.: US 2003/0192860 A1
(43) Pub. Date: Oct. 16, 2003

(54) Vacuum switch

(76) Inventors: Shuuichi Kikukawa, Hitachi (JP); Yasuaki Suzuki, Hitachi (JP); Masato Kobayashi, Hitachi (JP); Tooru Tanimizu, Hitachi (JP); Takuya Miyo, Hitachi (JP)

Correspondence Address: Mattingly, Stanger & Malur, P.C., 104 East Hume Avenue, Alexandria, VA, 22301, US

(21) Appl. No.: 10/303,803

(22) Filed: Nov. 26, 2002

(30) Foreign Application Priority Data
Apr. 16, 2002 (JP) 2002-113153

(51) Int. Cl. H01H 33/66

(52) U.S. Cl. 218/118

(57) ABSTRACT

An object of this invention is to provide a vacuum switch in which the assembling property of the parts to be accommodated in the interior of the vacuum container is improved, the configuration of the vacuum container is simplified, and the parts to be accommodated in the interior of the container can be assembled easily. This invention is a vacuum switch wherein a ground switch, a load switch, and an external connecting conductor to be electrically connected with the inside and outside of the vacuum container are provided in a vacuum container; the ground switch and the external connecting conductor are electrically connected in the vacuum container; and the vacuum container has a joint construction of a body portion having openings on both ends thereof, and a lid joined to the opening of the body.

### BACKGROUND OF THE INVENTION

1. Field of the Invention

This invention relates to a novel vacuum switch accommodating a plurality of switches.

2. Description of the Related Art

A construction having a plurality of switches in a vacuum container is disclosed in, for example, JP-A-2000-268685 and JP-A-2000-268686. Though the constructions in which a plurality of switches are accommodated in the vacuum container are disclosed, detailed structure and construction of the vacuum container are not stated at all in these publications.

When accommodating a plurality of switches in the vacuum container, assembling process of the internally located parts of these switches becomes complex and difficult with increase in number of switches. Further, when a plurality of vacuum switches are accommodated in a single vacuum container, the configuration of the vacuum container becomes larger and complex.

### SUMMARY OF THE INVENTION

It is an object of this invention to provide a vacuum switch in which the assembling property of the parts to be accommodated in the interior of the vacuum container is improved, the configuration of the vacuum container is simplified, and the parts to be accommodated in the interior of the container can be assembled easily.

According to this invention, the assembling property of the parts to be accommodated in the interior of the vacuum container is improved by opening both ends of the vacuum container, and the configuration of the vacuum container is simplified and assembly of the parts to be accommodated in the container may be facilitated by dividing the body portion of the vacuum container into a plurality of pieces and assembling the same into a unit, whereby a highly reliable vacuum switchgear is provided.

This invention is concerned with a vacuum switch provided with a plurality of shutoff portions or disconnecting portions, and ground switches in the vacuum container, wherein the vacuum container is opened at both ends, thereby increasing operability thereof.

In this invention, the vacuum shutoff switch portion includes required structure for performing vacuum shutoff, that is, a movable electrode, a fixed electrode, a conductor for supporting them, and a vacuum container for accommodating them. The disconnecting switch portion is a device connected to the shutoff portion for holding the shutoff switch in the disconnected state as needed, and includes a vacuum container for accommodating these elements.

In this invention, the vacuum container accommodating a plurality of circuits is preferably provided with a working space for accommodating and assembling the plurality of switches in the vacuum container, and is preferably capable of inspecting the assembled state of the internal parts.

Accordingly, in this invention, the vacuum container is constructed in such a manner that an opening is provided on the vacuum container, and the opening is to be closed with a lid after the parts are assembled in the container. As a consequent, assembling property in the interior of the vacuum container is improved, and the assembled state of the internal parts can be inspected, whereby a highly reliable vacuum switchgear is obtained.

Further, in this invention, since the opening of the vacuum container is joined with a lid by welding, and thus it is not necessary to heat the vacuum container in the vacuum furnace again for attaching the lid thereon after the parts in the vacuum container are assembled by soldering, the already soldered locations are not heated when attaching the lid, thereby improving reliability of the soldered portions.

In addition, in this invention, the vacuum container is constructed of a plurality of containers that are joined with each other, so that the configuration of each vacuum container can be simplified. Furthermore, since all the containers are made in the same configurations, the number of types of the parts is reduced and thus misassembling is avoided.

In other words, this invention provides a vacuum switch in which a ground switch, a load switch, and an external connecting conductor to be electrically connected to the inside and the outside of the a vacuum container are provided in the vacuum container, and the ground switch and the external connecting conductor are electrically connected in the vacuum container, wherein the vacuum container has a body portion having openings at both ends thereof, and a lid joined to the opening; and an electrode of at least one of the ground switch and the load switch are located so that the respective contact portions can be viewed through the opening, but not on the lid.

This invention also provides a vacuum switch wherein the vacuum container has a body portion having an opened opening and a lid joined to the opening by welding; the vacuum container has such construction that the wall surfaces except for the wall surface to which each electrode of at least one of the ground switch and the load switch is connected are curved out; or the vacuum container has a body portion formed of a tube and having opened openings at both ends and an installing portion for installing the electrode plastic-formed into a three-dimensional configuration so that the electrodes of at least one of the ground switch and the load switch can be installed except at the opening, and the opening is joined with a lid.

Further, this invention provides a vacuum switch wherein the vacuum container has a body portion having opened openings at both ends and lids provided at both ends of the body portion, a movable electrode of at least one of the ground switch and the load switch is provided so as to be capable of being moved by a bellows, and the bellows is inserted and joined into a recess formed on the upper surface of the body portion; the movable electrode of the ground switch in the vacuum container is insulated from the vacuum container and electrically connected to the movable rod connected to the outside, and the fixed electrode of the ground switch in the vacuum container is insulated from the vacuum container and electrically connected to the connecting conductor that is in turn connected to the outside; or the fixed electrode of the load switch is insulated in the vacuum container and electrically connected to the connecting conductor that is in turn connected to the outside.

Furthermore, this invention provides a vacuum switch wherein the fixed electrode of the ground switch and the fixed electrode of the load switch are integrally connected by a flat conductor in the vacuum container; the fixed electrode of the ground switch and the fixed electrode of the load switch are integrally connected by a conductor in the vacuum container, and the conductor is insulated in the vacuum container and electrically connected to the connecting conductor that is in turn connected to the outside of the vacuum container; or the vacuum container has a joint construction of a body portion having opened openings on both side surfaces of the cylindrical portion and a lid joined to at least one of the openings, and the electrode of at least one of the ground switch and the load switch is connected to the upper and lower surfaces of the body portion.

Still further, in this invention, a vacuum switch has a plurality of at least one of the ground switches and the load switches, the vacuum container includes and a body portion having opened openings on both side surfaces of the cylindrical portion and a lid joined to the openings on both sides of the joint construction that is constructed of the plurality of body portions joined at the openings with respect to each other, and the electrode of at least one of the ground switch and the load switch is connected to the upper and lower surface of the body portion; or the vacuum container has a joint construction of austenitic steel containing 0.03% or less of C, 18 to 20% of Cr, 9 to 13% of Ni, and 2.0 to 3.0% of Mo in weight. In addition, the austenitic steel preferably contains 1.0% or less, or more preferably, 0.3 to 0.8% of Si, and 2.0% or less, or more preferably, 0.5 to 1.5% of Mn.

Preferably, the vacuum container is joined by welding. Preferably, the vacuum container includes a body portion having an opening and a lid for closing the opening, and the lid includes a lug portion bent toward the outside of the vacuum container around the peripheral edge thereof and is joined by welding with the lug portion abutted against the inner peripheral surface of the body portion. Preferably, the vacuum container includes a body portion having an opening and a lid for closing the opening, and the lid is an arcuate shape curving out toward the outside of the vacuum container in cross section.

This invention is also a combination thereof.

### BRIEF DESCRIPTION OF THE DRAWINGS

FIG. 1 is a cross sectional view showing a construction of a vacuum switch according to Embodiment 1 of this invention.

FIG. 2 a cross sectional view showing a construction of a vacuum switch according to Embodiment 2 of this invention.

FIG. 3 is a top view showing a switch arrangement of the vacuum switch shown in FIG. 2.

FIG. 4 is a cross sectional view showing a construction of the vacuum switch according to Embodiment 3 of this invention.

FIG. 5 is a top view showing a switch arrangement of the vacuum switch shown in FIG. 4.

FIG. 6 is a cross sectional view showing a construction of the vacuum switch according to Embodiment 4 of this invention.

### DESCRIPTION OF THE PREFERRED EMBODIMENTS

Embodiment 1:

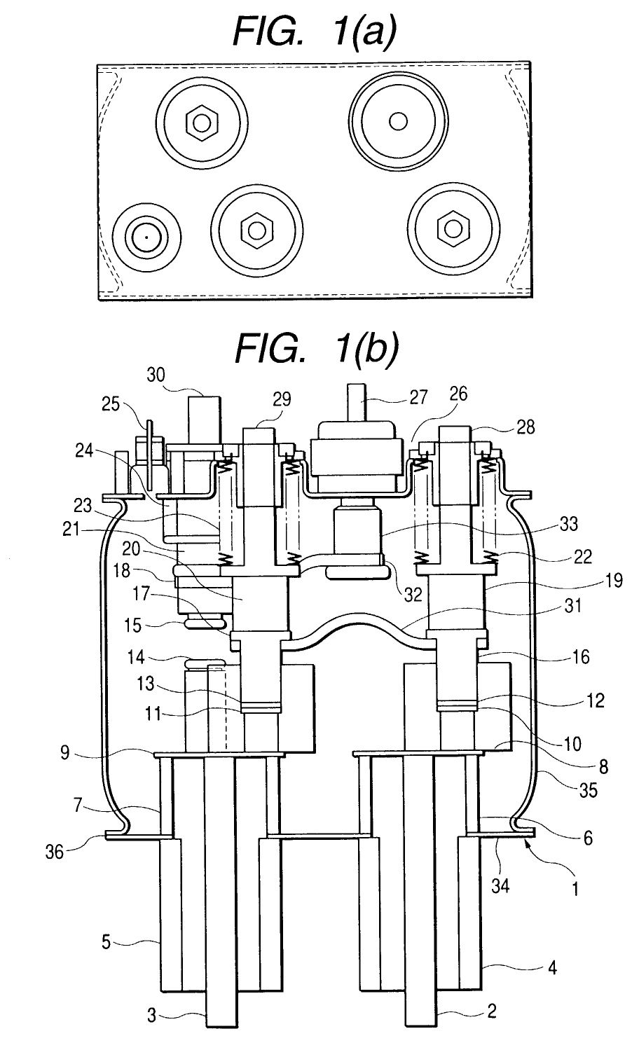

FIG. 1A and FIG. 1B show a top view and a cross sectional view of the vacuum switch according to this invention, respectively. The ground vacuum container 1 accommodates movable electrodes 12, 13 and the fixed electrodes 10, 11 of two shutoff switch portions or disconnecting switch portions and a movable electrode 15 and a fixed electrode 14 of a single ground device portion, and is provided with a vacuum pressure measuring terminal 25 of a vacuum pressure measuring device mounted on the ground vacuum container 1. As shown in the top view (FIG. 1A), the two shutoff switch portions or disconnecting switch portions being aligned in a row, and a single ground device portion and the external connecting conductor 27 being aligned in a row are arranged in parallel with respect to each other.

Most part of the ground vacuum container 1 is formed of conductive material as SUS316L (JIS standard), which is nonmagnetic stainless steel having high strength. The ground vacuum container 1 is grounded. The vacuum pressure of the ground vacuum container 1 is observed by a vacuum measuring device 25. Insulation between the ground vacuum container 1 and the conductor in the vacuum container is maintained by cylindrical insulators 4, 5, 6, 7, 19, 20, 21, 26 formed of sintered compact such as alumina, zirconia, and so on.

The external connecting conductor 27, including a central copper conductor portion, an upper metal cap, and a lower metal cylindrical body, is attached on the ground vacuum container 1 by soldering the central copper conductor portion thereto via the cylindrical insulator.

These insulators 4, 5, 6, 7 are joined to the body 34 of the ground vacuum container 1 by means of solder material containing 70% of Cu and 30% of Mn, and the insulators 6, 7 are connected with conductors 8, 9 formed of copper plate by means of Ag solder of BAg-8. Since a high residual stress is generated by soldering the insulators 4, 5, 6, 7 to the body 34of the ground vacuum container l, a member having high strength and anti-SCC characteristics is used for the ground vacuum container 1. The configuration of the body 34 of the ground vacuum container 1 viewed from the side of FIG. 1 coincides with the plane configuration of the lid 35.

In this embodiment, the ground vacuum container 1 is constructed in such a manner that the body portion 34 is formed of the nonmagnetic stainless steel pipe having openings on both ends or of a plate of the same material formed into a single piece of prescribed configuration as shown in the side view of FIG. 1 by welding, and that the lid 35 provided on the opening is formed of the same nonmagnetic stainless steel plate in a oval shape with the central portion curved outward and in circular arc with a flat central portion in cross section, and is provided with a joining portion 36 bent toward the outside of the ground vacuum container 1 so as to abut against the inner peripheral surface of the body portion 34 and to be joined by welding. Joining operation is to be performed after each part is installed.

The fixed electrode 10 and the movable electrode 12, the fixed electrode 11 and the movable electrode 13, and the fixed electrode 14 and the movable electrode 15 that can be brought into and out of contact with respect to each other are arranged in the ground vacuum container 1, and the switch is turned on and off by bringing into and out of contact with each movable electrode by the command of the operating mechanism. The movable electrodes 12, 13, 15 are connected to the movable conductors 16, 17, 18 respectively, which are connected in turn to the movable rod 28, 29, 30 via the insulators 19, 20, 21 respectively, and then to the operating mechanism. The movable rods 28, 29, 30 are hermetically sealed by the bellows 22, 23, 24 respectively.

The upper surface side of the body portion 34 on which the bellows 22, 23, 24 are mounted is formed with a recess so that the bellows 22, 23, 24 can be elastically provided therein, and with through holes at the central portion thereof so that the movable rods 28, 29 can be inserted.

The body portion 34 is formed with a through hole through which the connecting conductor 2, 3 are to be inserted at the lower portion thereof, and the cylindrical insulators 4, 5, 6, 7 are joined to the inside and outside thereof.

The fixed electrode 10 is connected to the connecting conductor 2 via the conductor 8, and thus is connected to the outside of the ground vacuum container 1. In the same manner, the fixed conductor 11 is connected to the connecting conductor 3 via the conductor 9, and thus connected to the ground vacuum container 1. The conductors 8, 9 formed of copper plate constitutes a part of the ground vacuum container, and are connected to the outside of the ground vacuum container 1 via the insulators 6, 7 in the ground vacuum container 1. The connecting conductors 2, 3 are further covered by the insulators 4, 5 outside the ground vacuum container 1. The conductor 9 is integrally soldered to the fixed electrode 14 of the ground switch.

The connecting conductor 2 and the connecting conductor 3 that are to be connected to the outside, being connected via the movable conductor 17, a flexible conductor 31, and the movable conductor 16, are electrically connected when the movable electrode 13 and the movable electrode 12 are in the ON state. The fixed conductor 14 of the grounded portion is electrically connected to the external connecting conductor 27 of the ground terminal portion when the movable electrode 15 of the grounded portion is in the ON-state since the movable conductor 18 is connected to the ground terminal conductor 33 via the flexible conductor 32.

The external connecting conductor 27 has the connecting portion with respect to the flexible conductor 32 and the ground terminal conductor 33 integrally connected with each other, and is insulated from the ground vacuum container 1 by the insulator 26.

The flexible conductors 31, 32 are arranged in the vacuum container, and thus are formed in such a manner that laminated sheets of oxygen free high conductivity copper (0.1 mm to 0.2 mm) are used for current carrying parts so that they can be operated in vacuum, and stainless steel sheets having layers of oxides and being thinner than the oxygen free high conductivity copper are inserted between each oxygen free high conductivity copper sheet so that oxygen free copper sheets do not adhere to each other in vacuum and its flexible characteristics thereof can be maintained.

The flexible conductor is curved out toward the opposite direction from the current carrying parts so as to secure a distance from the current carrying parts of the main circuit.

In addition, in the present embodiment, the connecting portions of the flexible conductor 32 and the movable conductor 18 of the ground switch are plated with silver, and then the silver plate on the connecting portions is melted at a vacuum soldering temperature during manufacturing of the vacuum container for connecting them with each other. Therefore, flexible conductors may be joined simultaneously with assembly of vacuum container by soldering, which enables assembly of the vacuum container without increasing the number of the process steps.

As is described thus far, according to the present embodiment, a highly reliable vacuum switch may be provided since assembling property of the parts to be accommodated in the interior of the vacuum container is improved, and the configuration of the vacuum container is simplified, and thus the assembly of the parts in the container is facilitated.

In the vacuum switch accommodating the ground switch according to the present embodiment, space required for the outside of the vacuum container may be reduced, thereby realizing a compact vacuum switch by connecting the respective ground switches to be accommodated in the interior of the vacuum container, and by providing a single contact terminal that is to be connected with the outside of the vacuum container.

Embodiment 2:

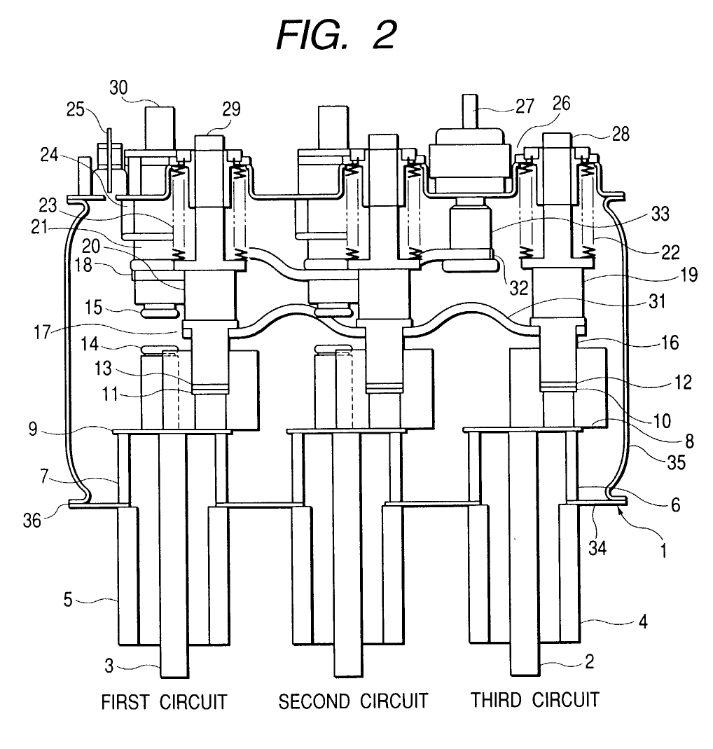

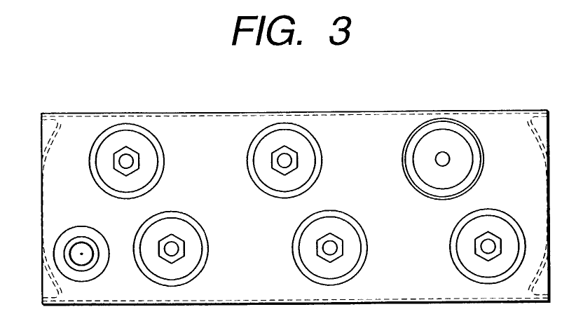

FIG. 2 is a cross sectional view of the vacuum switch according to this invention, and FIG. 3 is a top view of FIG. 2. In the present embodiment, a set of a switch for the shutoff portion or for the disconnecting portion and a ground switch is further accommodated in the vacuum container, and the circuits are connected by the flexible conductors 31, 32 respectively in addition to Embodiment 1 shown in FIG. 1. The basic structure of the present embodiment is completely the same as that in Embodiment 1, and the method of manufacturing is also the same. Three sets of switches for the shutoff portion or for the disconnecting portion and two sets of ground switches are accommodated in the vacuum container, and the former and the latter are arranged in a staggered pattern. The two sets of ground switches are connected to a single integrated external connecting conductor 27 by the flexible conductor 32.

The desired circuits may be electrically connected by turning on and off the movable electrodes of the respective circuit. Since the movable conductors of a first circuit and a second circuit are connected to the ground terminal portion via the flexible conductor in the ground switch, when the movable electrode at the grounded portion of the first circuit is turned on and the movable electrode of the grounded portion of the second circuit is turned off, the first circuit is grounded via the ground terminal portion, and when the movable electrode of the grounded portion of the first circuit is turned off and the movable electrode of the grounded portion of the second circuit is turned on, the second circuit can be grounded. When the movable electrodes of the grounded portions of the first circuit and the second circuit are turned on, both of the first circuit and the second circuit can be grounded via the ground terminal portions.

Also, even when the movable electrode of the grounded portion of the first circuit is turned on and the movable electrode of the grounded portion of the second circuit is turned off, in the case where the movable electrode of the shutoff portion or the disconnecting portion of the first circuit is in the ON state, the second circuit is grounded via the flexible conductor of the shutoff portion or the disconnecting portion. Therefore, there is provided an interlock for turning off the movable electrode of the shutoff portion or the disconnecting portion of the first circuit for preventing input/output operation when the movable electrode at the grounded portion of the second circuit is turned on. Likewise, in the second circuit, there is provided an interlock for turning off the movable electrode of the shutoff portion or the disconnecting portion of the second circuit for preventing input/output operation when the movable electrode of the grounded portion of the second circuit is in the on state.

As is described thus far, according to the present embodiment, a highly reliable vacuum switch may be provided since assembling property of the parts to be accommodated in the interior of the vacuum container is improved, and the configuration of the vacuum container is simplified, and thus the assembly of the parts in the container is facilitated.

In the vacuum switch accommodating the ground switch according to the present embodiment, space required for the outside of the vacuum container may be reduced, thereby realizing a compact vacuum switch by connecting the respective ground switches to be accommodated in the interior of the vacuum container within the vacuum container, and by providing a single ground terminal that is to be connected with the outside of the vacuum container.

Embodiment 3:

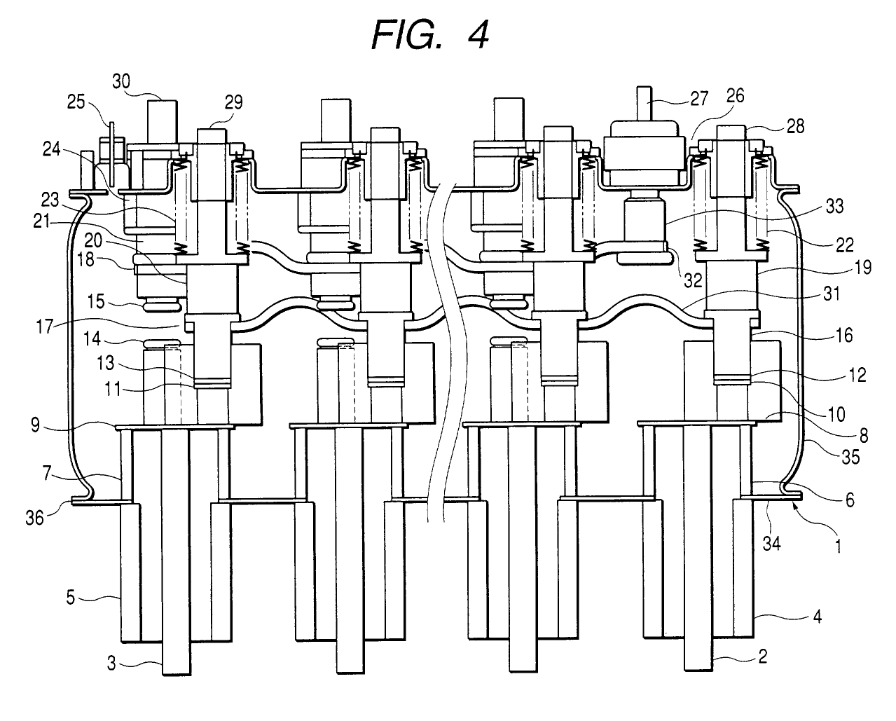

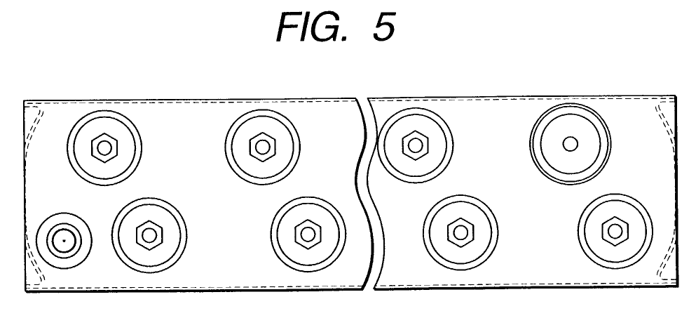

FIG. 4 is a cross sectional view of the vacuum switch of this invention and FIG. 5 is a top view thereof. The basic structure of the present embodiment is the completely the same as that of Embodiment 1, and the method of manufacturing is also the same. In the present embodiment, a switch for the shutoff portion or for the disconnecting portion and the ground switch are further accommodated in the vacuum container, and the respective circuits are connected by the flexible conductors 31, 32 respectively in addition to Embodiment 2 shown in FIG. 1. At least four sets of switches for the shutoff portion or for the disconnecting portion and at least three sets of ground switches are accommodated in the vacuum container, and the former and the latter are arranged in a staggered pattern.

Likewise, in the vacuum container accommodating at least three circuits as in this embodiment, the desired circuits may be grounded by connecting the respective circuits by the flexible conductor, and by turning the electrode of each circuit ON from a single ground terminal via the flexible conductor.

As is described thus far, according to the present embodiment, a highly reliable vacuum switch may be provided since assembling property of the parts to be accommodated in the interior of the vacuum container is improved, and the configuration of the vacuum container is simplified, and thus the assembly of the parts in the container is facilitated.

In the vacuum switch accommodating the ground switch according to the present embodiment, space required for the outside of the vacuum container may be reduced, thereby realizing a compact vacuum switch by connecting the respective ground switches to be accommodated in the interior of the vacuum container within the vacuum container, and by providing a single ground terminal that is to be connected with the outside of the vacuum container.

Embodiment 4:

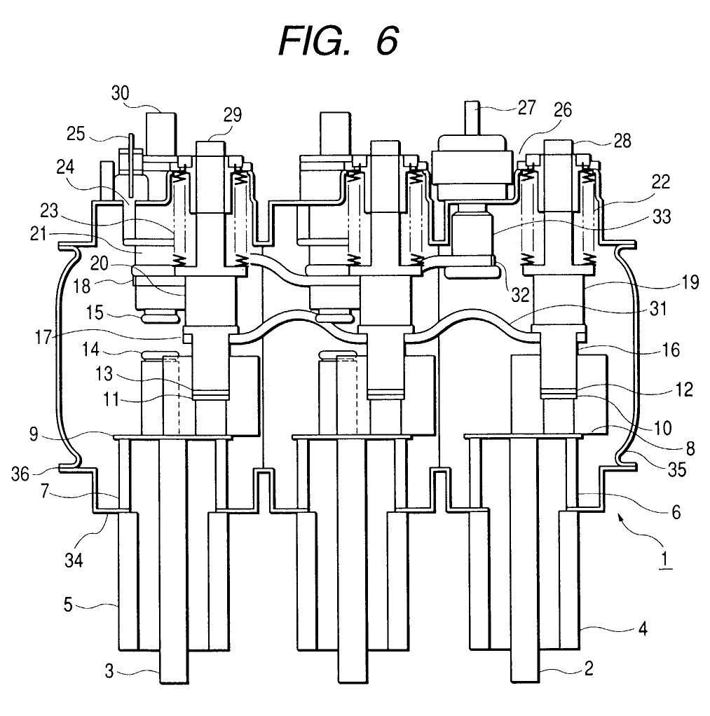

FIG. 6 is a cross sectional view of the vacuum switch of this invention. The basic structure of the present embodiment is completely the same as that in Embodiment 1, and the method of manufacturing is also the same. Three sets of switches for the shutoff portion or for the disconnecting portion and two sets of ground switch are accommodated in the vacuum container, and the former and the latter are arranged in a staggered pattern. The arrangement of the switches for each circuit is such that the arrangement of each switch for the shutoff portion or for the disconnecting portion and the arrangement of the ground switch and the external connecting conductor are disposed in parallel with respect to each other. Though the staggered pattern (a) is preferable in order to take a longer insulation distance, it is also possible to dispose them on a grid (b).

In the ground vacuum container 1 in the present embodiment, three pieces of SUS 316L steel pipes used in Embodiment 1 are respectively disposed in the vertical direction and plastic formed into a square shape in top view. The opening is formed on both side surfaces of each formed steel pipe, and the steel pipes are joined at the openings by welding as is at the welding portion 36. Each electrode for the ground switch and for the shutoff portion or for the disconnecting portion is provided with a projection for inserting the bellows 22 on the individual steel pipe by plastic-forming the plate of same material as shown in FIG. 6, and a cap formed with a hole for inserting the electrode is joined to the projection. The joint of each electrode is the same as in Embodiment 1. As described above, the lid 35 is joined by welding after the contacting state of each electrode is inspected through the opening.

As is described thus far, according to the present embodiment, a highly reliable vacuum switch may be provided since assembling property of the parts to be accommodated in the interior of the vacuum container is improved, and the configuration of the vacuum container is simplified, and thus the assembly of the parts in the container is facilitated.

In the vacuum switch accommodating the ground switch according to the present embodiment, space required for the outside of the vacuum container may be reduced, thereby realizing a compact vacuum switch by connecting the respective ground switches to be accommodated in the interior of the vacuum container in the vacuum container, and by providing a single contact terminal that is to be connected with the outside of the vacuum container.

As is described thus far, according to this invention, a highly reliable vacuum switch may be provided since assembling property of the parts to be accommodated in the interior of the vacuum container is improved, and the configuration of the vacuum container is simplified, and thus the assembly of the parts in the container is facilitated.

Further, according to this invention, space required for the outside of the vacuum container may be reduced, thereby realizing a compact vacuum switchgear by connecting the ground switches in the vacuum container, as well as by providing a single ground terminal that is to be connected with the outside of the vacuum container.

What is claimed is:

1. A vacuum switch comprising a ground switch, a load switch, and an external connecting conductor to be electrically connected to the outside of a vacuum container, wherein said ground switch, said load switch and said conductor are provided in said vacuum container; said ground switch and said external connecting conductor are electrically connected in said vacuum container; said vacuum container has a body portion having openings at both ends thereof and a lid joined to said opening; and an electrode of at least one of said ground switch and said load switch is located so that the respective contact portions can be viewed through said opening but not on said lid.

2. A vacuum switch comprising a ground switch, a load switch, and an external connecting conductor to be electrically connected to the outside of a vacuum container, wherein said ground switch, said load switch and said conductor are provided in said vacuum container; said ground switch and said external connecting conductor are electrically connected in said vacuum container; and said vacuum container has a body portion having an opened opening and a lid joined to said opening by welding.

3. A vacuum switch comprising a ground switch, a load switch, and an external connecting conductor to be electrically connected to the inside and outside of a vacuum container, wherein said ground switch, said load switch and said conductor are provided in said vacuum container; said ground switch and said external connecting conductor are electrically connected in said vacuum container; and said vacuum container has such construction that the wall surfaces except for the wall surface to which each electrode of at least one of said ground switch and said load switch is connected are curved out.

4. A vacuum switch comprising a ground switch, a load switch, and an external connecting conductor to be electrically connected to the outside of a vacuum container, wherein said ground switch, said load switch and said conductor are provided in said vacuum container; said ground switch and said external connecting conductor are electrically connected in said vacuum container; said vacuum container has a body portion formed of a tube and having opened openings at both ends and an installing portion for installing an electrode plastic-formed into a three-dimensional configuration so that said electrode of at least one of said ground switch and said load switch can be installed except at said opening; and said opening is joined with a lid.

5. A vacuum switch comprising a ground switch, a load switch, and an external connecting conductor to be electrically connected to the outside of a vacuum container, wherein said ground switch, said load switch and said conductor are provided in said vacuum container; said ground switch and said external connecting conductor are electrically connected in said vacuum container; said vacuum container has a body portion having opened openings at both ends and lids provided at both ends of the body portion; a movable electrode of at least one of said ground switch and said load switch is provided so as to be capable of being moved by a bellows; and said bellows is inserted and joined into a recess formed on the upper surface of said body portion.

6. A vacuum switch comprising a ground switch, a load switch, and an external connecting conductor to be electrically connected to the outside of a vacuum container, wherein said ground switch, said load switch and said conductor are provided in said vacuum container; said ground switch and said external connecting conductor are electrically connected in said vacuum container; a movable electrode of said ground switch is insulated from said vacuum container in said vacuum container and electrically connected to a movable rod connected to the outside; and a fixed electrode of said ground switch is insulated from said vacuum container in said vacuum container and electrically connected to a connecting conductor that is in turn connected to the outside.

7. A vacuum switch comprising a ground switch, a load switch, and an external connecting conductor to be electrically connected to the outside of a vacuum container, wherein said ground switch, said load switch and said conductor are provided in said vacuum container; said ground switch and said external connecting conductor are electrically connected in said vacuum container; and a fixed electrode of the load switch is insulated in said vacuum container and electrically connected to the connecting conductor that is in turn connected to the outside.

8. A vacuum switch comprising a ground switch, a load switch, and an external connecting conductor to be electrically connected to the outside of a vacuum container, wherein said ground switch, said load switch and said conductor are provided in said vacuum container; said ground switch and said external connecting conductor are electrically connected in said vacuum container; and a fixed electrode of said ground switch and a fixed switch of said load switch are integrally connected by a flat conductor in said vacuum container.

9. A vacuum switch comprising a ground switch, a load switch, and an external connecting conductor to be electrically connected to the outside of a vacuum container, wherein said ground switch, said load switch and said conductor are provided in said vacuum container; said ground switch and said external connecting conductor are electrically connected in said vacuum container; a fixed electrode of said ground switch and a fixed electrode of said load switch are integrally connected in said vacuum container by a conductor; and said conductor is insulated in said vacuum container and electrically connected to a connecting conductor that is in turn connected to the outside of said vacuum container.

10. A vacuum switch comprising a ground switch, a load switch, and an external connecting conductor to be electrically connected to the outside of a vacuum container, wherein said ground switch, said load switch and said conductor are provided in said vacuum container; said ground switch and said external connecting conductor are electrically connected in said vacuum container; said vacuum container has a joint construction of a body portion having opened openings on both side surfaces and a lid joined to at least one of said openings; and an electrode of at least one of said ground switch and said load switch is connected to the upper and lower surfaces of said body portion.

11. A vacuum switch comprising a ground switch, a load switch, and an external connecting conductor to be electrically connected to the outside of a vacuum container, wherein said ground switch, said load switch and said conductor are provided in said vacuum container; said ground switch and said external connecting conductor are electrically connected in said vacuum container; said vacuum container further has a plurality of at least either the ground switches or the load switches; said vacuum container includes a body portion having opened openings on both side surfaces of the cylindrical portion and a lid joined to said openings on both sides of the joint construction that is constructed of the plurality of body portions joined at said openings with respect to each other; and an electrode of at least one of said ground switch and said load switch is connected to the upper and lower surfaces of said body portion.

12. A vacuum switch comprising a ground switch, a load switch, and an external connecting conductor to be electrically connected to the outside of a vacuum container, wherein said ground switch, said load switch and said conductor are provided in said vacuum container; said ground switch and said external connecting conductor are electrically connected in said vacuum container; and said vacuum container has a joint construction of austenitic steel containing 0.03% or less of C, 18 to 20% of Cr, 9 to 13% of Ni, and 2.0 to 3.0% of Mo in weight.

13. The vacuum switch according to any one of claim 1, wherein said vacuum container is joined by welding.

14. The vacuum switch according to any one of claim 1, wherein said vacuum container includes a body portion having an opening and a lid for closing the opening, and the lid includes a lug portion bent toward the outside of said vacuum container around the peripheral edge thereof and is joined by welding with the lug portion abutted against the inner peripheral surface of said body portion.

15. The vacuum switch according to any one of claim 1, wherein said vacuum includes a body portion having an opening and a lid for closing the opening, and the lid is in an arcuate shape curving out toward the outside of said vacuum container in cross section.
